(19) United States
(12) Patent Application Publication
(10) Pub. No.: US 2026/0107209 A1
(43) Pub. Date: Apr. 16, 2026

(54) METHOD AND APPARATUS OF SUPPORTING DATA FORWARDING

(71) Applicant: Lenovo (Beijing) Limited, Beijing (CN)

(72) Inventors: Shuigen Yang, Shanghai (CN); Mingzeng Dai, Shanghai (CN); Lianhai Wu, Beijing (CN); Congchi Zhang, Shanghai (CN); Le Yan, Shanghai (CN)

(73) Assignee: Lenovo (Beijing) Limited, Beijing (CN)

(21) Appl. No.: 19/112,389

(22) PCT Filed: Nov. 3, 2022
(86) PCT No.: PCT/CN2022/129566

§ 371 Date: Mar. 17, 2025

(51) Int. Cl. H04W 36/36; H04W 36/00; H04W 36/02; H04W 40/36

(52) U.S. Cl. CPC H04W 36/362; H04W 36/00692; H04W 36/02; H04W 40/36

(57) ABSTRACT

Embodiments of the present application relate to a method and apparatus of supporting data forwarding. An exemplary apparatus, e.g., a candidate target master node (MN) may include: a processor, configured to: determine information of routing optimization for early data forwarding associated with one or more candidate target secondary nodes (SNs) at least prepared by the MN, wherein the early data forwarding is for a conditional handover (CHO) with secondary cell group (SCG) of a user equipment (UE); and a transceiver, coupled to the processor and configured to: transmit the information of routing optimization to a source MN.

### TECHNICAL FIELD

Embodiments of the present application generally relate to wireless communication technology, especially to a method and apparatus of supporting data forwarding, e.g., supporting early data forwarding for a conditional handover (CHO) with secondary cell group (SCG) of a user equipment (UE).

### BACKGROUND

Wireless communication systems are widely deployed to provide various telecommunication services such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems such as long term evolution (LTE) systems, LTE-advanced (LTE-A) systems, or LTE-A Pro systems, and fifth generation (5G) systems which may also be referred to as new radio (NR) systems.

When UE moves from one cell to another cell, a serving cell change will be performed at some points. In the legacy, the serving cell change is done by explicit radio resource control (RRC) reconfiguration signalling to trigger the synchronization of the target cell based on layer 3 (L3) measurements report, which usually leads to long latency, large overhead, and long interruption time. Therefore, CHO is introduced to improve the handover performance, which is defined as a handover that is executed by the UE when one or more handover execution conditions are met. The UE will start evaluating the execution condition(s) after receiving the CHO configuration and stop evaluating the execution condition(s) after a handover is executed.

Regarding SCG, it is a group of serving cells associated with secondary node (SN), including primary secondary cell (PSCell) and optionally one or more secondary cells (SCells). In multi-radio (MR) dual connectivity (DC) scenario, the UE will perform the CHO from the source master node (MN) towards potential target MNs, and will perform conditional PSCell addition (CPA) or conditional PSCell change (CPC) towards potential SNs. The CPA is defined as a PSCell addition that is executed by the UE when execution condition(s) is met, and the CPC is defined as a PSCell change that is executed by the UE when execution condition(s) is met. In short, such a scenario is called CHO with SCG. For the CHO with SCG, there are multiple potential target MNs as well as one target SCG (or only one potential target SCG) or multiple potential target SCGs. Regarding a potential target MN, it can also be called as or deemed as a target MN, a candidate target MN, a candidate MCG, a candidate target MCG, a target MCG, or a candidate MN, etc. Regarding a target SCG or potential target SCG, it can also be called as or deemed as a candidate target SCG, a candidate SCG, a candidate target SN, a target SN, or a candidate SN, etc.

To reduce the latency for data forwarding or interruption of data forwarding, early data forwarding is introduced for the CHO and CPA/CPC, where the data forwarding is started in advance to multiple potential target nodes. If early data forwarding is applied, the source node, e.g., source MN or source SN will initiate data forwarding before the UE executes the handover, to a potential target node of interest. Since there are multiple candidate target MNs (e.g., up to 8 according to current specifications) and each candidate target MN may prepare multiple candidate target SNs (e.g., up to 8 according to current specifications) for the CHO with SCG, there are multiple data forwarding paths for the same UE. Without data forwarding optimization, the data will be sent via multiple paths, which will abuse resources of the network in some scenarios.

Given the above, the industry desires technology to improve data forwarding for CHO with SCG.

### SUMMARY OF THE APPLICATION

One objective of the embodiments of the present application is to provide a technical solution of supporting data forwarding, e.g., a method and apparatus of supporting data forwarding to at least improve early data forwarding for CHO with SCG.

Some embodiments of the present application provide a MN, e.g., a candidate target MN, which includes: a processor, configured to: determine information of routing optimization for early data forwarding associated with one or more candidate target SNs at least prepared by the MN, wherein the early data forwarding is for a CHO with SCG of a UE; and a transceiver, coupled to the processor and configured to: transmit the information of routing optimization to a source MN.

In some embodiments of the present application, the transceiver is configured to: receive, from a candidate target SN of the one or more candidate target SNs, an identity of the candidate target SN, wherein the identity of the candidate target SN is a globally unique identity.

In some embodiments of the present application, the information of routing optimization indicates at least one of the following: an identity of one candidate target SN of the one or more candidate target SNs; a random number allocated at the one candidate target SN; or an indicator of same candidate target SN, indicating that a data forwarding address associated with the early data forwarding will map to a same data forwarding address of the one candidate target SN.

According to some embodiments of the present application, the information of routing optimization further indicates an estimated arrival probability for the UE towards the one candidate target SN prepared by the MN.

According to some embodiments of the present application, the transceiver is configured to: receive information indicating that the same data forwarding address is shared by other candidate target MNs with the MN, so that the indicator of same candidate target SN is determined by the MN.

According to some embodiments of the present application, the early data forwarding associated with the UE is indirect early data forwarding for CHO with one target SCG.

In some embodiments of the present application, the information of routing optimization indicates at least one of the following: an estimated arrival probability for the UE towards one candidate target SN prepared by the MN of the one or more candidate target SNs; or information of sharing data forwarding address, indicating a number of candidate target MNs using a same data forwarding address of the one candidate target SN.

According to some embodiments of the present application, the early data forwarding associated with the UE is direct early data forwarding for CHO with multiple candidate SCGs.

In some embodiments of the present application, the information of routing optimization indicates at least one of the following: identities of the one or more candidate target SNs; information of sharing data forwarding address, indicating a number of candidate target MNs using a same data forwarding address of the one candidate target SN; one or more first estimated arrival probabilities, each first estimated arrival probability for the UE towards a corresponding candidate target SN of the one or more candidate target SNs prepared by the MN; or one or more second estimated arrival probabilities, each second estimated arrival probability for the UE towards a corresponding candidate target SN of the one or more candidate target SNs prepared by another candidate target MN different from the MN.

According to some embodiments of the present application, a second estimated arrival probability associated with a candidate target SN is received from the candidate target SN via an SN addition request acknowledge message or an SN modification required message.

According to some embodiments of the present application, the transceiver is configured to: transmit, to the candidate target SN, information indicating first time based on that second estimated arrival probabilities associated with the candidate target SN will be provided; and receive a message indicating the second estimated arrival probabilities associated with the candidate target SN. In some scenarios, the transceiver is configured to: receive, from the source MN, information indicating second time based on that the second estimated arrival probabilities associated with the candidate target SN will be provided, wherein the first time is equal to or shorter than the second time.

According to some embodiments of the present application, the transceiver is configured to: receive, from the source MN, a destination for data forwarding for SN-terminated bearers, wherein the destination is an identity of a target SN determined by the source MN.

According to some embodiments of the present application, the early data forwarding associated with the UE is indirect early data forwarding for CHO with multiple candidate SCGs.

According to some embodiments of the present application, information related to the number of candidate target MNs using the same data forwarding address of the one candidate target SN is indicated via an SN addition request acknowledge message or an SN modification required message. In some scenarios, the transceiver is configured to: transmit, to the one candidate target SN, information indicating first time based on that the information related to the number of candidate target MNs using the same data forwarding address of the one candidate target SN will be provided; and receive the information related to the number of candidate target MNs using the same data forwarding address of the one candidate target SN. In some scenarios, the transceiver is configured to: receive, from the source MN, information indicating second time based on that the information of sharing data forwarding address will be provided, wherein the first time is equal to or shorter than the second time. Exemplary information related to the number of candidate target MNs using the same data forwarding address of the one candidate target SN is indicated by the one candidate target SN with a numerical value or with at least identities of other candidate target MNs using the same data forwarding address in addition to the MN.

Exemplary first time is a time length or a time point. Exemplary second time is also a time length or a time point.

According to some embodiments of the present application, the time length is time to wait, indicating the maximum allowed waiting times to provide the information of sharing data forwarding address.

According to some embodiments of the present application, the time length is time to wait, indicating the maximum allowed waiting times to provide the second estimated arrival probabilities associated with the candidate target SN.

Some other embodiments of the present application provide another MN, e.g., a source MN, which includes: a processor; and a transceiver, coupled to the processor and configured to: transmit, to a candidate target MN of one or more candidate target MNs, a handover request for a CHO with SCG of a UE; and receive, from the candidate target MN, information of routing optimization for early data forwarding associated with one or more candidate target SNs at least prepared by the candidate target MN, wherein the early data forwarding is for the CHO with SCG.

According to some embodiments of the present application, information of routing optimization for early data forwarding is received from the candidate target MN via a handover request acknowledge message or a message later than the handover request acknowledge message.

In some embodiments of the present application, the transceiver is configured to: transmit, to the candidate target MN, information indicating time based on that the information of sharing data forwarding address will be provided.

According to some embodiments of the present application, the information of sharing data forwarding address is received via a handover request acknowledge message or a message later than the handover request acknowledge message.

In some embodiments of the present application, the transceiver is configured to: transmit, to the candidate target MN, information indicating time based on that the second estimated arrival probabilities associated with the corresponding candidate target SN will be provided.

In some embodiments of the present application, the processor is configured to: determine that data will be forwarded to only one candidate target MN of the one or more candidate target MNs based on information of routing optimization from the one or more candidate target MNs.

According to some embodiments of the present application, in the case that more than one estimated arrival probability is received from more than one candidate target MN, the only one candidate target MN is a candidate target MN with a maximum estimated arrival probability. In some scenarios, the processor is configured to: perform the early data forwarding to the only one candidate target MN; or indicate the only one candidate target MN to a source SN.

In some embodiments of the present application, the processor is configured to: determine that data will be forwarded based on only one data forwarding address based on the information of routing optimization from the one or more candidate target MNs.

According to some embodiments of the present application, in the case that more than one estimated arrival probability is received from more than one candidate target MN, the only one data forwarding address is a data forwarding address with a maximum estimated arrival probability. In the case that a data forwarding address is provided by different candidate target MNs with different estimated arrival probabilities, an estimated arrival probability of the data forwarding address is an average of the different estimated arrival probabilities.

According to some embodiments of the present application, in the case that information of sharing data forwarding address is received from more than one candidate target MN, the only one data forwarding address is a data forwarding address used by a maximum number of candidate target MNs.

According to some embodiments of the present application, the processor is configured to: indicate the only one data forwarding address to a source SN.

In some embodiments of the present application, the processor is configured to: in the case that the information of routing optimization from more than one candidate target MN includes information on identities of one or more candidate target SNs, determine a candidate target MN with a maximum number of candidate target SNs as only one candidate target MN to which early data will be forwarded.

According to some embodiments of the present application, the processor is configured to: perform the early data forwarding to the only one candidate target MN; or indicate the only one candidate target MN to a source SN.

In some embodiments of the present application, the processor is configured to: in the case that the information of routing optimization from more than one candidate target MN includes information on one or more first estimated arrival probabilities, determine a candidate target SN with a maximum estimated arrival probability as a destination for data forwarding for SN-terminated bearers, wherein the maximum estimated arrival probability is a maximum first estimated arrival probability.

According to some embodiments of the present application, the processor is configured to: in the case that the information of routing optimization from more than one candidate target MN includes information on one or more second estimated arrival probabilities associated with a candidate target SN, an estimated arrival probability of the candidate target SN is an average of the first estimated arrival probability and different second estimated arrival probabilities from different candidate target MNs.

According to some embodiments of the present application, the transceiver is configured to: transmit, to the candidate target MN, the destination for data forwarding for SN-terminated bearers, wherein the destination is an identity of the candidate target SN with the maximum estimated arrival probability. The processor is configured to: perform the early data forwarding to the candidate target MN for SN-terminated bearers and indicate to the candidate target MN the destination; or indicate to a source SN the destination.

Some embodiments of the present application provide a SN, e.g., a candidate target SN, which includes: a processor; and a transceiver, coupled to the processor and configured to: receive, from a candidate target MN, first information related to a CHO with SCG of a UE; and transmit, to the candidate target MN, second information related to routing optimization for early data forwarding for the CHO with SCG.

In some embodiments of the present application, the second information is transmitted via an SN addition request acknowledge message or an SN modification required message.

In some embodiments of the present application, the second information indicates at least one of the following: an identity of the SN; a random number allocated at the SN; or information indicating that a same data forwarding address is shared by other candidate target MNs with the candidate target MN.

In some embodiments of the present application, the second information indicates information related to a number of candidate target MNs using a same data forwarding address of the SN with a numerical value or with at least identities of other candidate target MNs using a same data forwarding address of the SN in addition to the candidate target MN.

According to some embodiments of the present application, the transceiver is configured to: receive, from the candidate target MN, information indicating time based that the information related to a number of candidate target MNs using a same data forwarding address of the SN will be provided; and determine information related to a number of candidate target MNs using the same data forwarding address based on the indicated time.

In some embodiments of the present application, the second information indicates at least one of the following: an identity of the SN; information related to a number of candidate target MNs using a same data forwarding address of the SN; or one or more second estimated arrival probabilities, each second estimated arrival probability for the UE towards the SN prepared by another candidate target MN different from the candidate target MN.

According to some embodiments of the present application, the transceiver is configured to: receive, from the candidate target MN, information indicating time based on that at least one of the information related to a number of candidate target MNs using a same data forwarding address of the SN or the one or more second estimated arrival probabilities will be provided; and report, to the candidate target MN, at least one of the information related to a number of candidate target MNs using a same data forwarding address of the SN or the one or more second estimated arrival probabilities based on the indicated time.

Given the above, embodiments of the present application provide a method and apparatus of supporting data forwarding, which can at least optimize early data forwarding for CHO with SCG and reduce resource abuse. Accordingly, the present application can facilitate and improve the implementation of NR.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a wireless communication system according to some embodiments of the present application.

FIG. 2a illustrates an exemplary scenario of indirect early data forwarding for CHO with one target SCG.

FIG. 2b illustrates an exemplary scenario of indirect early data forwarding for CHO with multiple candidate SCGs.

FIG. 2c illustrates an exemplary scenario of direct early data forwarding for CHO with one target SCG.

FIG. 2d illustrates an exemplary scenario of direct early data forwarding for CHO with multiple candidate SCGs.

FIG. 3 is a flow chart of an exemplary procedure of supporting data forwarding in Scenario 1 according to some embodiments of the present application.

FIG. 4 is a flow chart of an exemplary procedure of supporting data forwarding in Scenario 2 according to some embodiments of the present application.

FIG. 5 is a flow chart of another exemplary procedure of supporting data forwarding in Scenario 2 according to some other embodiments of the present application.

FIG. 6 is a flow chart of an exemplary procedure of supporting data forwarding in Scenario 3 according to some embodiments of the present application.

FIG. 7 is a flow chart of another exemplary procedure of supporting data forwarding in Scenario 3 according to some other embodiments of the present application.

FIG. 8 illustrates a block diagram of an apparatus of supporting data forwarding according to some embodiments of the present application.

FIG. 9 illustrates a block diagram of an apparatus of supporting data forwarding according to some other embodiments of the present application.

### DETAILED DESCRIPTION

The detailed descriptions of the appended drawings are intended as descriptions of preferred embodiments of the present application and are not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP 5G, 3GPP LTE, and so on. It is contemplated that along with the developments of network architectures and new service scenarios, all embodiments in the present application are also applicable to similar technical problems. Moreover, the terminologies recited in the present application may change, which should not affect the principle of the present application.

In a NR-DC scenario, a UE with multiple transceivers may be configured to utilize resources provided by two different nodes connected via non-ideal backhauls. Wherein one node may provide NR access and the other one node may provide either evolved-universal mobile telecommunication system (UMTS) terrestrial radio access (UTRA) (E-UTRA) or NR access. One node may act as an MN and the other node may act as an SN. The MN and SN are connected via a network interface, e.g., Xn interface as specified in 3GPP standard documents, and at least the MN is connected to the core network (CN).

For example, FIG. 1 illustrates a schematic diagram of a wireless communication system 100 in accordance with some embodiments of the present application.

As shown in FIG. 1, the wireless communication system 100 may be a dual connectivity system 100 includes at least one UE 101, at least one MN 102, and at least one SN 103. In particular, the dual connectivity system 100 in FIG. 1 includes one shown UE 101, one shown MN 102, and one shown SN 103 for illustrative purpose. Although a specific number of UEs 101, MNs 102, and SNs 103 are depicted in FIG. 1, it is contemplated that any number of UEs 101, MNs 102, and SNs 103 may be included in the wireless communication system 100.

Referring to FIG. 1, the UE 101 may connect to the MN 102 and the SN 103 via an interface, for example, Uu interface as specified in 3GPP standard documents. The MN 102 and the SN 103 may be connected with each other via a network interface, for example, Xn interface as specified in 3GPP standard documents. The MN 102 may be connected to the core network via a network interface (not shown in FIG. 1), for example, NG interface as specified in 3GPP standard documents. The UE 101 may be configured to utilize resources provided by the MN 102 and the SN 103 to perform data transmission.

In some embodiments of the present application, the UE 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. In some other embodiments of the present application, the UE 101 may include a portable wireless communication device, a smart phone, a cellular telephone, a flip phone, a device having a subscriber identity module, a personal computer, a selective call receiving circuitry, or any other device that is capable of sending and receiving communication signals on a wireless network. In some other embodiments of the present application, the UE 101 may include wearable devices, such as smart watches, fitness bands, optical head-mounted displays, or the like. Moreover, the UE 101 may be referred to as a subscriber unit, a mobile, a mobile station, a user, a terminal, a mobile terminal, a wireless terminal, a fixed terminal, a subscriber station, a user terminal, or a device, or described using other terminology used in the art.

The MN 102 refers to a radio access network (RAN) node that provides a control plane connection to the core network. In an embodiment of the present application, in the E-UTRA-NR DC (EN-DC) scenario, the MN 102 may be an eNB. In another embodiment of the present application, in the next generation E-UTRA-NR DC (NGEN-DC) scenario, the MN 102 may be a next generation (ng)-eNB. In yet another embodiment of the present application, in the NR-DC scenario or the NR-E-UTRA DC (NE-DC) scenario, the MN 102 may be a gNB. An MN 102 may also be referred to as a master-NG-RAN (M-NG-RAN) node in some embodiments of the present application.

An MCG may refer to a group of serving cells associated with the MN 102, and include a primary cell (PCell) and optionally one or more SCells. The PCell may provide a control plane connection to the UE 101.

The SN 103 may refer to a radio access network node without control plane connection to the core network but providing additional resources to the UE 101. In some embodiments of the present application, in the EN-DC scenario, the SN 103 may be an en-gNB. In some other embodiments of the present application, in the NR-DC scenario, the SN 103 may be a ng-eNB. In yet another embodiment of the present application, in the NR-DC scenario or the NGEN-DC scenario, the SN 103 may be a gNB. A SN 103 may also be referred to as a secondary-NG-RAN (S-NG-RAN) node in some embodiments of the present application.

A SCG may refer to a group of serving cells associated with the SN, and include a PSCell and optionally one or more SCells. The PCell of the MCG and the PSCell of the SCG may also be referred to as a special cell (SpCell).

For CHO with SCG, early data forwarding may be indirect early data forwarding or direct early data forwarding. In the case of indirect early data forwarding, a source MN or a source SN will forward the data to a candidate target MN, and then the candidate target MN forwards the data to a candidate target SN. In the case of direct early data forwarding, a source MN or a source SN will forward the data to a candidate target SN directly, without the forwarding by a candidate target MN. Without data forwarding optimization, the data will be sent via multiple paths, which will abuse resources of the network and may also cause other issues.

For example, for indirect early data forwarding for CHO with one target SCG, the source node, e.g., source MN has the data forwarding address towards the candidate target MN but does not have the data forwarding address towards the candidate target SN. Without data forwarding optimization, the source MN may send the data to multiple candidate target MNs, which will be forwarded to the same candidate target SN by the multiple candidate target MNs. That is, the data will be sent via multiple paths, which will abuse resources of the network. In addition, the candidate target SN shall remove the multiplied data every now and then if multiplied data from multiple paths are received, which requires high processing capability and storage capacity.

For direct early data forwarding for CHO with multiple candidate SCGs, the source node, e.g., source MN has the data forwarding address towards the candidate target SN, and it sends the data to the candidate target SN directly. However, without data forwarding optimization, there are multiple paths for directly early data forwarding, and the data will also be sent via multiple paths.

For indirect early data forwarding for CHO with multiple candidate SCGs, the source node, e.g., source MN has the data forwarding address towards the candidate target MN but does not have the data forwarding address towards the candidate target SN. Therefore, the source MN will send the data to the candidate target MN(s), which will be forwarded to multiple candidate target SNs by the candidate target MN(s). Thus, the same candidate target SN may be prepared by multiple candidate target MNs, and may receive the multiplied data via multiple paths. In addition, the same candidate target MN may prepare multiple candidate target SNs and the same data will be forwarded to multiple candidate target SNs.

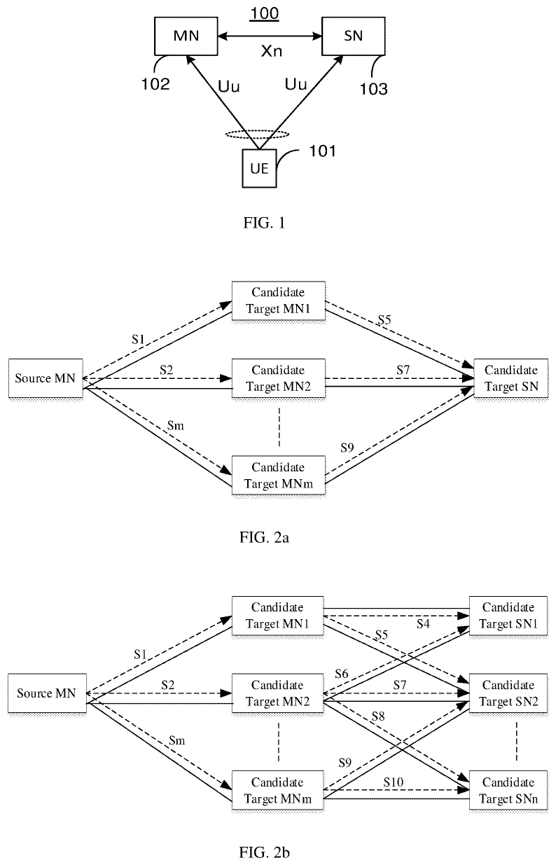

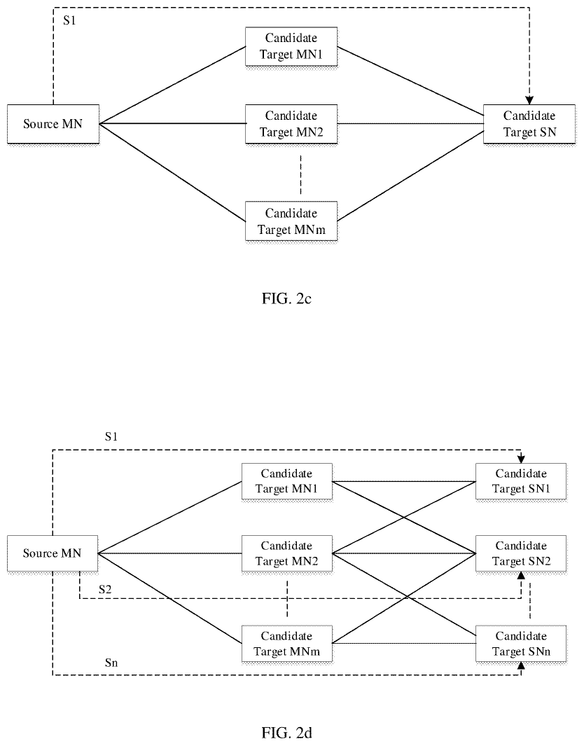

FIGS. 2a-2d illustrate four exemplary scenarios of early data forwarding for CHO with SCG without data forwarding optimization, wherein, FIG. 2a illustrates an exemplary scenario of indirect early data forwarding for CHO with one target SCG; FIG. 2b illustrates an exemplary scenario of indirect early data forwarding for CHO with multiple candidate SCGs; FIG. 2c illustrates an exemplary scenario of direct early data forwarding for CHO with one target SCG; and FIG. 2d illustrates an exemplary scenario of direct early data forwarding for CHO with multiple candidate SCGs. Dash lines, e.g., S1, S2 etc. represent data forwarding paths.

Referring to FIG. 2a, in an exemplary scenario of indirect early data forwarding for CHO with one target SCG, there is only one candidate target SN (one target SN) and multiple (e.g., m>1) candidate target MNs. The candidate target SN is prepared by candidate target MN1, candidate target MN2 . . . and candidate target MNm. The source MN will forward the data to the candidate target MN1 via S1, and then the candidate target MN1 will forward the data to the candidate target SN via S5. Similarly, the source MN will forward the data to the candidate target MN2 via S2, and then the candidate target MN2 will forward the data to the candidate target SN via S7, and so on. The source MN will forward the data to the candidate target MNm via Sm, and then the candidate target MNm will forward the data to the candidate target SN via S9.

Referring to FIG. 2b, in an exemplary scenario of indirect early data forwarding for CHO with multiple candidate SCGs, there are multiple (e.g., n>1) candidate target SNs and multiple (e.g., m>1) candidate target MNs. Each candidate target SN may be prepared by one or more candidate target MNs. For example, candidate target SN1 is prepared by candidate target MN1 and candidate target MN2, candidate target SN2 is prepared by candidate target MN1, candidate target MN2 and candidate target MNm . . . and candidate target SNn is prepared by candidate target MN2 and candidate target MNm. The source MN will forward the data to the candidate target MN1 via S1, and then the candidate target MN1 will forward the data to the candidate target SN1 via S4 and to the candidate target SN2 via S5. Similarly, the source MN will forward the data to the candidate target MN2 via S2, and then the candidate target MN2 will forward the data to the candidate target SN1 via S6, to the candidate target SN2 via S7, and to the candidate target SNn via S8, and so on. The source MN will forward the data to the candidate target MNm via Sm, and then the candidate target MNm will forward the data to the candidate target SN2 via S9 and to the candidate target SNn via S10.

Similar to FIG. 2a, in an exemplary scenario of direct early data forwarding for CHO with one target SCG shown in FIG. 2c, there is only one candidate target SN (one target SN) and multiple (e.g., m>1) candidate target MNs. The candidate target SN is prepared by candidate target MN1, candidate target MN2 . . . and candidate target MNm. The source MN will forward the data to the candidate target SN via S1 directly.

Similar to FIG. 2b, in an exemplary scenario of direct early data forwarding for CHO with multiple candidate target SCGs shown in FIG. 2d, there are multiple (e.g., n>1) candidate target SNs and multiple (e.g., m>1) candidate target MNs. Each candidate target SN may be prepared by one or more candidate target MNs. For example, candidate target SN1 is prepared by candidate target MN1 and candidate target MN2, candidate target SN2 is prepared by candidate target MN1, candidate target MN2 and candidate target MNm . . . and candidate target SNn is prepared by candidate target MN2 and candidate target MNm. The source MN will forward the data to the candidate target SN1 via S1 directly, forward the data to the candidate target SN2 via S2 directly, and forward the data to the candidate target SNn via SN directly.

It can be seen that there are multiple data forwarding paths for the same UE in FIGS. 2a, 2b and 2d. Without data forwarding optimization, the data will be sent via multiple paths, and the issues stated above will happen. In the case that the source node is a source SN rather than source MN, similar issues will also happen.

At least to solve the above issues on data forwarding for CHO with SCG, embodiments of the present application provide technical solutions of supporting data forwarding, e.g., a method and apparatus of supporting data forwarding, which can at least optimize early data forwarding for CHO with SCG and decrease resource abuse in network.

For example, some embodiments of the present application provide a method of supporting data forwarding, which can be performed by a candidate target MN, e.g., candidate target MN1 shown in FIGS. 2a, 2b and 2d or the like. The method includes determining information of routing optimization (or, routing optimization information) for early data forwarding associated with one or more candidate target SNs at least prepared by the candidate target MN, wherein the early data forwarding is for a CHO with SCG of a UE. The method also includes transmitting the information of routing optimization to a source MN, e.g., by a handover request acknowledge (ACK) message or other message(s).

Some other embodiments of the present application provide another method of supporting data forwarding, which can be performed by a source MN, e.g., the source MN shown in FIGS. 2a, 2b and 2d or the like. The method includes transmitting, to a candidate target MN of one or more candidate target MNs, a handover request for a CHO with SCG of a UE, e.g., via a handover request message. The method also includes receiving, from the candidate target MN, information of routing optimization for early data forwarding associated with one or more candidate target SNs at least prepared by the candidate target MN, e.g., by a handover request ACK message or other message(s), wherein the early data forwarding is for the CHO with SCG.

In some scenarios (Scenario 1), e.g., where the early data forwarding associated with the UE is indirect early data forwarding for CHO with one target SCG as shown in FIG. 2 or the like, the information of routing optimization indicates at least one of the following: an identity of one candidate target SN of the one or more candidate target SNs; a random number allocated at the one candidate target SN; or an indicator of same candidate target SN, indicating that a data forwarding address associated with the early data forwarding will map to a same data forwarding address of the one candidate target SN.

Regarding a data forwarding address (also called as data forwarding information), it may be a downlink (DL) data forwarding address, or an uplink (UL) data forwarding address, or a DL and UL data forwarding address. An exemplary data forwarding address contains transport layer (TNL) information for the establishment of data forwarding tunnels towards to the target node (MN or SN). The TNL information corresponds to an internet protocol (IP) address and a general packet radio service tunneling protocol (GTP) tunnel endpoint identifier (TEID). In addition, a data forwarding address is per at least one of protocol data unit (PDU) session or DRB level, e.g., per PDU level, or per DRB level, or per PDU and DRB level. When the data forwarding address is per DRB level or per PDU and DRB level, it will include the DRB ID.

According to some embodiments of the present application, for simplicity, a data forwarding address associated with the early data forwarding will map to the same data forwarding address of a candidate target SN indicates a data forwarding address associated with the early data forwarding will map to the same candidate target SN. According to some embodiments of the present application, for simplicity, the data will be forwarded to the same data forwarding address allocated by a candidate target SN indicates the data will be forwarded to the same candidate target SN.

Based on the information of routing optimization, the source MN will know that the data will be forwarded to the same candidate target SN, and will select (or determine) one candidate target MN for data forwarding. The candidate target MN may be randomly selected by the source MN or based on a configured or predefined rule. For example, the information of routing optimization may also indicate an estimated arrival probability for the UE towards the same candidate target SN prepared by the MN. A candidate target MN can provide the estimated arrival probability of a candidate target SN prepared by the candidate target MN. In the case that a candidate target SN is prepared by multiple candidate target MNs, each candidate target MN will have an estimated arrival probability for the candidate target SN, which may be the same or different. When the source MN knows that the data will be forwarded to the same candidate target SN and also receives the data forwarding addresses from multiple candidate target MNs with different estimated arrival probabilities, the source MN may select the candidate target MN with the maximum estimated arrival probability for data forwarding.

In some other scenarios (Scenario 2), e.g., where the early data forwarding associated with the UE is direct early data forwarding for CHO with multiple candidate SCGs as shown in FIG. 2d or the like, the information of routing optimization indicates at least one of the following: an estimated arrival probability for the UE towards one candidate target SN prepared by the MN of the one or more candidate target SNs; or information of sharing data forwarding address, indicating a number of candidate target MNs using a same data forwarding address of the one candidate target SN.

Based on the routing optimization information received from multiple candidate target MNs, the source MN will select one candidate target SN for data forwarding. In some cases, the source MN may indicate the time based on that the information of sharing data forwarding address will be provided by the candidate target MN or corresponding candidate target SN to avoid the race competition. The candidate target MN may also indicate similar time to the candidate target SN independently or pursuant to the indication from the source MN. For example, in the case the time is required, the T-SN will wait for the required time to count or determine a number of candidate target MNs using the same data forwarding address.

In some yet other scenarios (Scenario 3), e.g., where the early data forwarding associated with the UE is indirect early data forwarding for CHO with multiple candidate SCGs as shown in FIG. 2b or the like, the information of routing optimization indicates at least one of the following: identities of the one or more candidate target SNs; information of sharing data forwarding address, indicating a number of candidate target MNs using a same data forwarding address of the one candidate target SN; one or more first estimated arrival probabilities, each first estimated arrival probability for the UE towards a corresponding candidate target SN of the one or more candidate target SNs prepared by the MN; or one or more second estimated arrival probabilities, each second estimated arrival probability for the UE towards a corresponding candidate target SN of the one or more candidate target SNs prepared by another candidate target MN different from the MN.

Based on the routing optimization information received from multiple candidate target MNs, the source MN will determine a candidate target MN as only one candidate target MN to which early data will be forwarded or determine a candidate target SN as a destination for data forwarding for SN-terminated bearers. Similarly, there may be required time based on that the information of sharing data forwarding address and/or the one or more second estimated arrival probabilities will be provided to avoid the race competition.

Some yet other embodiments of the present application provide yet another method of supporting data forwarding, which can be performed by a candidate target SN or the like. The method includes receiving, from a candidate target MN, first information related to a CHO with SCG of a UE, e.g., via an SN addition request message. The method also includes transmitting, to the candidate target MN, second information related to routing optimization for early data forwarding for the CHO with SCG, e.g., via an SN addition request ACK message or SN modification required message. Based the received second information, the candidate target MN can provide the routing optimization information for the source MN.

In some scenarios (Scenario 1), e.g., where the early data forwarding associated with the UE is indirect early data forwarding for CHO with one target SCG, the second information indicates at least one of the following: an identity of the SN; a random number allocated at the SN; or information indicating that a same data forwarding address is shared by other candidate target MNs with the candidate target MN.

In some other scenarios (Scenario 2), e.g., where the early data forwarding associated with the UE is direct early data forwarding for CHO with multiple candidate SCGs, the second information indicates information related to a number of candidate target MNs using a same data forwarding address of the SN with a numerical value or with at least identities of other candidate target MNs using the same data forwarding address of the SN in addition to the candidate target MN. The candidate target MN may determine or derive a number of candidate target MNs using the same data forwarding address based on the second information or directly use that indicated in the second information, and transmit information of sharing data forwarding address to the source MN. For example, the second information may directly indicate a number of candidate target MNs using the same data forwarding address, the candidate target MN will directly indicate the same number as the information of sharing data forwarding address to the source MN. In the case that the candidate target MN receives identities of other candidate target MNs using the same data forwarding address (in some other cases, the second information may indicate identities of all candidate target MNs using the same data forwarding address), the candidate target MN may determine a number of candidate target MNs using the same data forwarding address based on the identities of other candidate target MNs (or all candidate target MNs) using the same data forwarding address. In some other cases, the candidate target MN may also directly use the identities of at least other candidate target MNs using the same data forwarding address indicated in the second information as the information of sharing data forwarding address to the source MN, and the source MN will determine or derive a number of candidate target MNs using the same data forwarding address based on the indicated identities.

In some yet other scenarios (Scenario 3), e.g., where the early data forwarding associated with the UE is indirect early data forwarding for CHO with multiple candidate SCGs, the second information indicates at least one of the following: an identity of the SN; information of sharing data forwarding address with a numerical value or with identities of other candidate target MNs using a same data forwarding address of the SN in addition to the candidate target MN, or one or more second estimated arrival probabilities, each second estimated arrival probability for the UE towards the SN prepared by another candidate target MN different from the candidate target MN.

More detailed embodiments of the present application will be illustrated hereafter in view of some exemplary data forwarding scenarios. Persons skilled in the art should understand that although MNs and SNs in NR-DC are illustrated in the exemplary embodiments, the illustrated technical solution may also be applied to similar RAN nodes and/or similar scenarios and should not be limited to specific apparatuses and scenarios. In addition, although different exemplary embodiments are illustrated focusing on different technical measures for clearness, they can be combined in various manners by persons skilled in the art under the disclosure and teaching of the present application while not specifically illustrated.

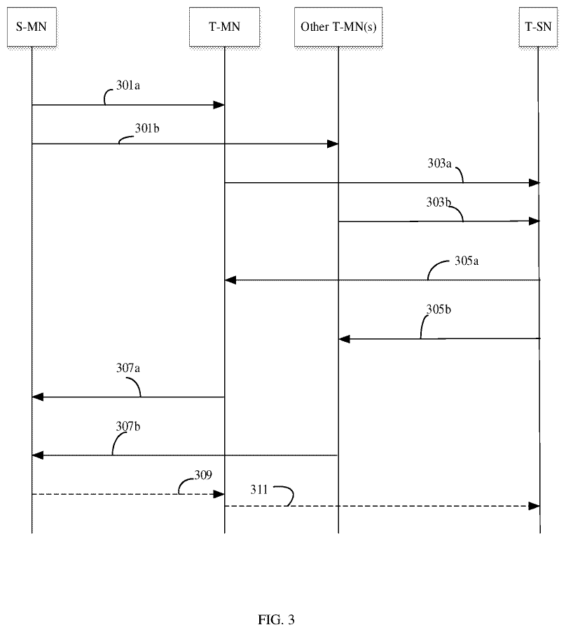

FIG. 3 is a flow chart of an exemplary procedure of supporting data forwarding in Scenario 1 according to some embodiments of the present application. Although there are multiple candidate target MNs, operations of only one candidate target MN are illustrated as an example in detail for simplification and clearness. Persons skilled in the art should well know the corresponding operation in other candidate target MN(s) under the disclosure and teaching of the specifically illustrated candidate target MN, which may be the same as, or similar to, or different from that of the illustrated target MN due to adopting the same, or similar, or different solutions taught by various embodiments of the present application.

Referring to FIG. 3, in step 301a, the source MN (also referred to as “S-MN” for simplification) starts a CHO procedure by sending a handover request message or the like to a candidate target MN (also referred to as “T-MN” for simplification), e.g., candidate target MN1 as shown in FIG. 2a. The handover request message or the like includes MCG configuration and, if the UE is configured with an SCG, SCG configuration. The handover request message or the like also includes CHO related information. The CHO related information includes the S-MN identity (ID) and the UE ID allocated at the S-MN.

Similarly, in step 301b, the S-MN may also start the CHO handover procedure by sending a handover request message or the like to one or more other candidate target MNs (also referred to as “other T-MN(s)” for simplification), e.g., T-MN2 or T-MNm as shown in FIG. 2a.

In step 303a, the T-MN will send an SN addition request message or the like to a candidate target SN (also referred to as “T-SN” for simplification) at least prepared by the candidate target MN, including the CHO related information. In some embodiments of the present application, besides the S-MN ID and the UE ID allocated at the S-MN, the CHO related information may also include the estimated arrival probability for the UE towards the candidate target SN prepared by the candidate target MN.

Other T-MN(s) may perform identical or similar operations in step 303b.

The T-SN will reply with an SN addition request acknowledge message or the like in step 305a. The SN addition request acknowledge message or the like includes data forwarding address allocated by the T-SN, which is related to a PDU session for DRBs configured with an SN terminated bearer option.

The T-SN may also provide routing optimization related information to the T-MN in the same or the like message, to assist the T-MN to determine routing optimization information.

In some embodiments of the present application, the T-SN may indicate an identity of the T-SN. An exemplary identity of the T-SN is a globally unique identity of the T-SN. If there are multiple user planes (UPs) for the T-SN, the identity of the T-SN will be the combination of a global node identity of the candidate target SN and a UP identity which uniquely identifies the UP at least within the candidate target SN.

In some other embodiments of the present application, the T-SN may indicate a random number to the T-MN. For example, based on the received S-MN ID and the UE ID allocated at the S-MN, the T-SN will know that the SN addition requests from multiple T-MNs are for the same UE. The T-SN may allocate the same data forwarding address for the UE and the same random number for the data forwarding address, and then send them to the T-MN.

In some yet other embodiments of the present application, after knowing that the SN addition requests from multiple T-MNs are for the same UE, the T-SN may transmit information to the T-MN, indicating that the same data forwarding address is also shared by other candidate target MNs.

The T-SN may transmit at least one of the above in the routing optimization related information to the T-MN, e.g., only the identity of the T-SN, or only the random number, or only the information indicating that the same data forwarding address is also shared by other candidate target MNs, or any combination of them.

The T-SN will reply similar messages to other T-MN(s) in step 305b if similar messages are received from the other T-MN(s) in step 303b.

After receiving the SN addition request ACK message, the T-MN will transmit a handover request acknowledge message or the like to the S-MN in step 307a, which includes a data forwarding address allocated by the T-MN. The data forwarding address is related to a PDU session for DRBs configured with an SN terminated bearer option.

The T-MN may also include the routing optimization information in the same message or different message(s). Based on the information received from the T-SN, the routing optimization information includes at least one of: the T-SN identity; the random number allocated at the T-SN; or an indicator of same candidate target SN. The indicator of same candidate target SN (also referred to as same candidate target SN indicator) indicates that the data forwarding address associated with the early data forwarding will map to the same data forwarding address allocated by the candidate target SN (also referred to as “the data forwarding address associated with the early data forwarding will map to the same candidate target SN” for simplification). In some embodiments of the present application, the indicator of same candidate target SN is generated by the T-MN based on the information indicating that the same data forwarding address is shared by other T-MN(s) with the T-MN. An exemplary indicator of same candidate target SN is an enumerated type. If the indicator of same candidate target SN is set to true, it means the data will be forwarded to the same data forwarding address allocated by the T-SN (also referred to as “the data will be forwarded to the same T-SN” for simplification).

In some embodiments of the present application, besides at least one of the T-SN identity, the random number and the same candidate target SN indicator is indicated to the S-MN, the routing optimization information may further include an estimated arrival probability for the UE towards the T-SN prepared by the T-MN.

Other T-MN(s) may transmit similar message(s) to the S-MN in step 307b.

Based on the routing optimization information, the S-MN will know that the data will be forwarded to the same T-SN and will select (or determine) one candidate target MN for data forwarding. In some cases, the S-MN will perform the early data forwarding to the selected one candidate target MN, e.g., T-MN in step 309 and the selected one candidate target MN will forward the data to the T-SN in step 311. In some other cases, the S-MN will indicate to a source SN the selected candidate target MN so that the source SN will perform the data forwarding to the selected candidate target MN.

For example, if the T-SN identities received from multiple T-MNs are the same, the S-MN will determine that the data will be forwarded to the same T-SN. Therefore, the S-MN will forward the data to a selected candidate target MN, but not to other candidate target MN(s). For example, if the T-SN identities received from candidate target MN1, candidate target MN2 and candidate target MNm shown in FIG. 2a are the same, the S-MN will select only one of candidate target MN1, candidate target MN2 and candidate target MNm for data forwarding.

In the case that the random number allocated at the T-SN received from multiple T-MNs are the same, the S-MN will determine that the data will be forwarded to the same T-SN. Therefore, S-MN will forward the data to a selected candidate target MN, but not to other candidate target MN(s). For example, if the random number received from candidate target MN1, candidate target MN2 and candidate target MNm shown in FIG. 2a are the same, the S-MN will select only one of candidate target MN1, candidate target MN2 and candidate target MNm for data forwarding.

In the case that the S-MN receives the same candidate target SN indicator from multiple T-MNs, the S-MN will determine that the data will be forwarded to the same T-SN. Therefore, the S-MN will forward the data to a selected candidate target MN, but not to other candidate target MN(s). For example, if the same candidate target SN indicators are received from candidate target MN1, candidate target MN2 and candidate target shown in FIG. 2a, the S-MN will select only one of candidate target MN1, candidate target MN2 and candidate target MNm for data forwarding.

In the case that the S-MN determines that the data will be forwarded to the same T-SN and also receives estimated arrival probabilities towards the same T-SN from multiple T-MNs, the S-MN will select the candidate target MN with the maximum estimated arrival probability for data forwarding. For example, if candidate target MN1 provides the estimated arrival probability with 90%, candidate target MN2 provides the estimated arrival probability with 80%, and candidate target MNm provides the estimated arrival probability with 70%, the S-MN will select candidate target MN1 for data forwarding to the T-SN.

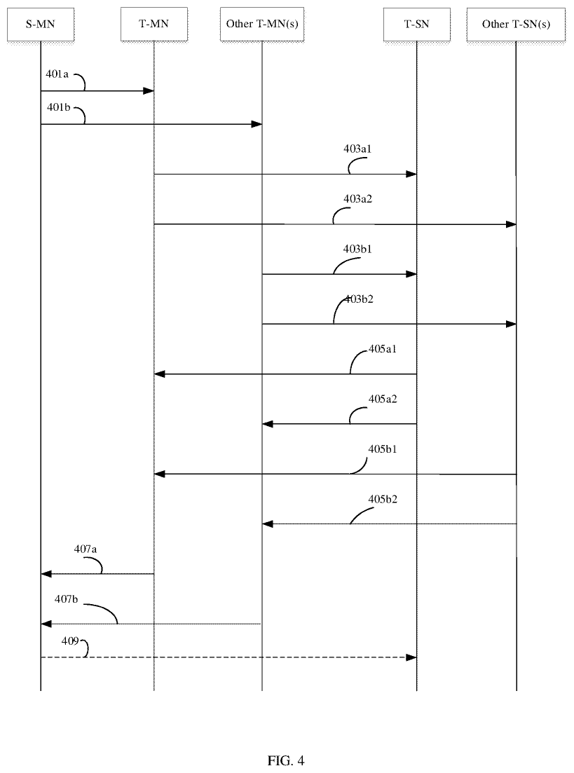

FIG. 4 is a flow chart of an exemplary procedure of supporting data forwarding in Scenario 2 according to some embodiments of the present application. Although there are multiple candidate target MNs and multiple candidate target SNs, operations of only one candidate target MN and one candidate target SN at least prepared by the candidate target MN are illustrated as an example in detail for simplification and clearness. Persons skilled in the art should well know the corresponding operation in other candidate target MN(s) and candidate target SN(s) under the disclosure and teaching of the specifically illustrated candidate target MN and candidate target SN, which may be the same as, or similar to, or different from that of the illustrated target MN due to adopting the same, or similar, or different solutions taught by various embodiments of the present application.

Referring to FIG. 4, in step 401a, the S-MN starts a CHO procedure by sending a handover request message or the like to a T-MN, e.g., candidate target MN1 as shown in FIG. 2d. The handover request message or the like includes MCG configuration and, if the UE is configured with an SCG, SCG configuration. The handover request message or the like also includes CHO related information. The CHO related information includes the S-MN ID and the UE ID allocated at the S-MN.

Similarly, in step 401b, the S-MN may also start the CHO handover procedure by sending a handover request message or the like to one or more other T-MN(s), e.g., candidate target MN2 or candidate target MNm as shown in FIG. 2d.

In step 403a1, the T-MN will send an SN addition request message or the like to a candidate target SN (also referred to as “T-SN” for simplification), including the CHO related information. In some embodiments of the present application, besides the S-MN ID and the UE ID allocated at the S-MN, the CHO related information may also include the estimated arrival probability for the UE towards the candidate target SN prepared by the T-MN.

The T-MN may also send the same message to other candidate target SN(s) (also referred to as “other T-SN(s)” for simplification) in step 403a2. Other T-MN(s) may perform identical or similar operations to the T-SN in step 403b1 and to other T-SN(s) in step 403b2.

The T-SN will reply with an SN addition request acknowledge message or the like in step 405a1. The SN addition request acknowledge message or the like includes data forwarding address allocated by the T-SN, which is related to a PDU session for DRBs configured with an SN terminated bearer option.

The T-SN may also provide routing optimization related information to the T-MN in the same or the like message, to assist the T-MN to determine routing optimization information.

Since the data forwarding address is allocated by the T-SN for each T-MN, and the T-SN can obtain the number of T-MN sharing the data forwarding address. Thus, in some embodiments of the present application, the T-SN may indicate information related to a number of candidate target MNs using the same data forwarding address of the T-SN, so that the T-MN can determine the information of sharing data forwarding address. The information related to a number of candidate target MNs using the same data forwarding address of the T-SN may be indicated explicitly with a numerical value, e.g., 3, or implicitly with at least identities of other T-MN(s) using the same data forwarding address of the T-SN.

In some cases, the T-MN may indicate first time based on that the information related to a number of candidate target MNs using the same data forwarding address of the T-SN will be provided, e.g., included in the SN addition request message or the like in step 403a1. Exemplary of the first time is a time length or a time point. For example, a time length may be time to wait, which indicates the maximum allowed waiting times for the T-SN to provide the number of candidate target MNs using the same data forwarding address of the T-SN. The T-SN will determine the information related to the number of candidate target MNs using the same data forwarding address based on the indicated time, e.g., only counting the number of candidate target MNs using the same data forwarding address at the indicated time point, or only counting the number of candidate target MNs using the same data forwarding address at or within the first time determined based on the time length.

In some embodiments of the present application, the T-MN may receive information indicating second time based on that the information of sharing data forwarding address will be provided from the S-MN, e.g., included in the handover request message or the like in step 401a. Slimily, the second time is a time length or a time point. Exemplary time length may be time to wait, which indicates the maximum allowed waiting times for the T-MN to provide the number of candidate target MNs using the same data forwarding address of the T-SN. The T-MN will ensure that the first time is equal to or shorter than the second time.

In the case that the first time is indicated, it is assumed that the T-SN will reply the SN addition request acknowledge message or the like in step 405al after the information related to a number of candidate target MNs using the same data forwarding address of the T-SN is obtained based on the first time, so that the T-SN can indicate the information related to a number of candidate target MNs using the same data forwarding address of the T-SN within the SN addition request acknowledge message or the like in step 405a1.

The T-SN will reply similar messages to other T-MN(s) in step 405b1 if it receives similar messages from the other T-MN(s) in step 403b1. Other T-SN(s) will reply similar messages to the T-MN in step 405a2 and to other T-MN(s) in step 405b2, if they receive similar messages from the T-MN and the other T-MN(s) in steps 403a2 and 403b2.

After receiving the SN addition request acknowledge message from T-SN, the T-MN will transmit a handover request acknowledge message or the like to the S-MN in step 407a, which includes a data forwarding address allocated by the T-SN. The data forwarding address is related to a PDU session for DRBs configured with an SN terminated bearer option.

The T-MN may also include the routing optimization information in the same message or different message(s). Based on the information received from the T-SN, the routing optimization information includes at least one of: an estimated arrival probability for the UE towards the T-SN prepared by the T-MN, or the information of sharing data forwarding address, indicating a number of candidate target MNs using the same data forwarding address of the T-SN.

Other T-MN(s) will transmit similar message(s) to the S-MN in step 407b.

Based on the routing optimization information, the S-MN will select (or determine) one data forwarding address (or one candidate target SN) for data forwarding. The source MN will perform the early data forwarding to the selected one candidate target SN, e.g., T-SN according to the selected data forwarding address in step 409; or indicate to a source SN the selected candidate target SN so that the source SN will perform the data forwarding to the selected candidate target SN.

For example, in the case that the S-MN receives different data forwarding addresses from multiple T-MNs with different estimated arrival probabilities, the S-MN will select the data forwarding address sent from the T-MN with the maximum estimated arrival probability for data forwarding. For example, if candidate target MN1 shown in FIG. 2d provides the data forwarding address 1 towards SN1 with an estimated arrival probability of 90%, candidate target MN2 provides the data forwarding address 2 towards SN2 with an estimated arrival probability of 50%, and candidate target MNm provides the data forwarding address n towards candidate target SNn with an estimated arrival probability of 80%, then the S-MN will select the data forwarding address 1 for data forwarding. The data will be sent from the S-MN or source SN to candidate target SN1 directly.

In some cases, the same T-SN may be prepared by multiple T-MNs, e.g., candidate target SN1 is prepared by candidate target MN1 and candidate target MN2. When the S-MN receives the same data forwarding address with different estimated arrival probabilities from multiple T-MNs, the S-MN may further process the received estimated arrival probabilities associated with the T-SN, e.g., averaging the received estimated arrival probabilities. For example, for the same data forwarding address, e.g., data forwarding address of candidate target SN1, candidate target MN1 provides the estimated arrival probability with 80%, while candidate target MN2 provides the estimated arrival probability with 60%, then the S-MN will derive or determine that the estimated arrival probability for the UE towards candidate target SN1 is 70%.

In the case that information of sharing data forwarding address is received from more than one T-MN, the S-MN may select a data forwarding address used by the maximum number of candidate target MNs for data forwarding or by the maximum number of data forwarding address being shared. For example, candidate target MN1 as shown in FIG. 2d provides the number of candidate target MNs sharing data forwarding address 1 towards candidate target SN1 is 5, while the candidate target candidate target MN2 provides the number of candidate target MNs sharing data forwarding address 2 towards the candidate target SN2 is 2, the source MN may select the data forwarding address 1 for data forwarding.

In the case that both information on estimated arrival probability and information of sharing data forwarding address is received from more than one candidate target MN, the S-MN will select the data forwarding address based on its own implementation in various manners.

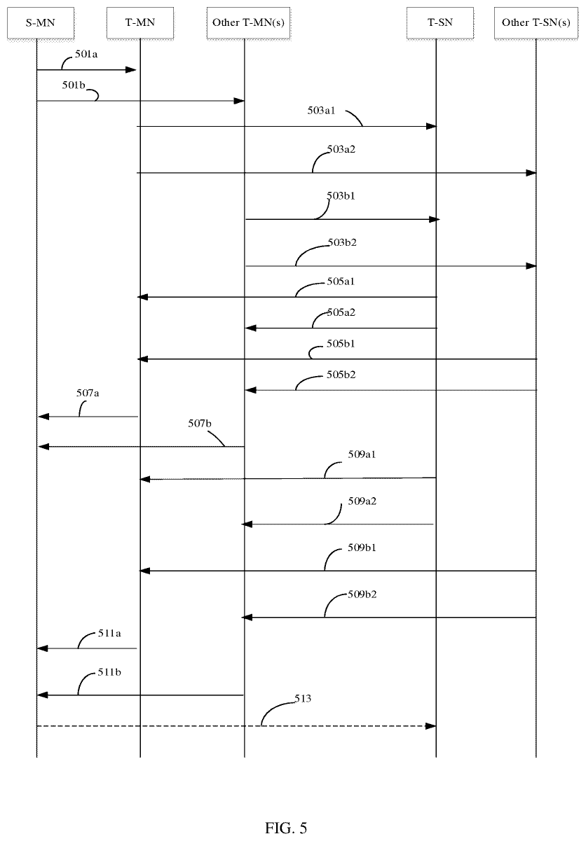

FIG. 5 is a flow chart of another exemplary procedure of supporting data forwarding in Scenario 2 according to some other embodiments of the present application. Similarly, although there are multiple candidate target MNs and multiple candidate target SNs, operations of only one candidate target MN and one candidate target SN at least prepared by the candidate target MN are illustrated as an example in detail for simplification and clearness. Persons skilled in the art should well know the corresponding operation in other candidate target MN(s) and candidate target SN(s) under the disclosure and teaching of the specifically illustrated candidate target MN and candidate target SN, which may be the same as, or similar to, or different from that of the illustrated target MN due to adopting the same, or similar, or different solutions taught by various embodiments of the present application.

Compared with FIG. 4, FIG. 5 differs in that the routing optimization related information will be transmitted to the T-MN in an SN modification required message or the like rather than an SN addition request ACK message. Steps 501a to 503b2 are identical with steps 401a to 403b2; and steps 505al to 505b2 can also refer to steps 405al to 405b2, wherein, only legacy SN addition request ACK message will be sent and no routing optimization related information will be sent to the T-MN.

In step 507a, the T-MN may only reply a handover request ACK message, or include within the handover request ACK message, routing optimization information indicating an estimated arrival probability for the UE towards the T-SN prepared by the T-MN. Step 507b is similar. If receiving the routing optimization information indicating an estimated arrival probability, the S-MN may perform routing optimization based on the received estimated arrival probabilities as illustrated above or wait for further routing optimization information.

In step 509a1, the T-SN will transmit a message indicating the information related to a number of candidate target MNs using the same data forwarding address of the SN to the T-MN, e.g., by an SN modification required message or the like, which may be a numerical value, e.g., 3 or identities of other T-MN(s) using the same data forwarding address of the T-SN, or identities of all T-MN(s) using the same data forwarding address of the T-SN etc. Steps 509a2 to 509b2 are similar.

In some cases, the T-MN may indicate first time based on that the information related to a number of candidate target MNs using the same data forwarding address of the SN will be provided, e.g., including in the SN addition request message or the like in step 503a1. The T-SN will determine the information related to the number of candidate target MNs using the same data forwarding address based on the indicated time. In the case that the T-MN receive second time based on that the information of sharing data forwarding address will be provided from the S-MN, e.g., including the handover request message in step 501a, the first time will be equal to or shorter than the second time.

After receiving the information related to the number of candidate target MNs using the same data forwarding address indicated by the T-SN, the T-MN will transmit routing optimization information including information of sharing data forwarding address to the S-MN in step 511a, e.g., by a message after the handover request ACK message. In some embodiments of the present application, the T-MN may not transmit any routing optimization information to the S-MN in step 507a, and will transmit the routing optimization information including at least one of the estimated arrival probability for the UE towards the T-SN prepared by the T-MN or the information of sharing data forwarding address to the source MN as illustrated in step 407a illustrated in FIG. 4.

Other T-MN(s) will transmit similar message(s) to the S-MN in step 511b.

Similar to FIG. 4, based on the routing optimization information, the S-MN will select (or determine) one data forwarding address (or one candidate target SN) for data forwarding. The source MN will perform the early data forwarding to the selected one SN, e.g., T-SN according to the selected data forwarding address in step 513; or indicate to a source SN the selected candidate target SN so that the source SN will perform the data forwarding to the selected candidate target SN.

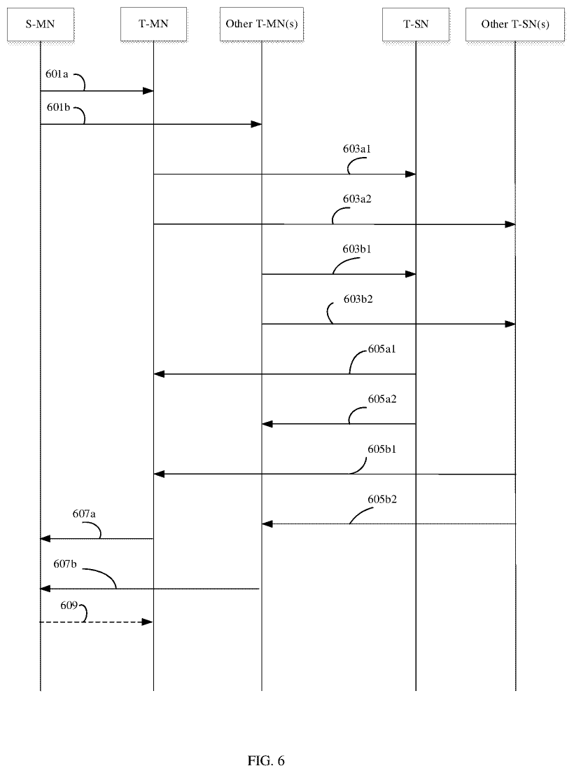

FIG. 6 is a flow chart of an exemplary procedure of supporting data forwarding in Scenario 3 according to some embodiments of the present application. Similarly, although there are multiple candidate target MNs and multiple candidate target SNs, operations of only one candidate target MN and one candidate target SN at least prepared by the candidate target MN are illustrated as an example in detail for simplification and clearness. Persons skilled in the art should well know the corresponding operation in other candidate target MN(s) and candidate target SN(s) under the disclosure and teaching of the specifically illustrated candidate target MN and candidate target SN, which may be the same as, or similar to, or different from that of the illustrated target MN due to adopting the same, or similar, or different solutions taught by various embodiments of the present application.

Referring to FIG. 6, in step 601a, the S-MN starts a CHO procedure by sending a handover request message or the like to a T-MN, e.g., candidate target MN1 as shown in FIG. 2b. The handover request message or the like includes MCG configuration and, if the UE is configured with an SCG, SCG configuration. The handover request message or the like also includes CHO related information. The CHO related information includes the S-MN ID and the UE ID allocated at the S-MN.

Similarly, in step 601b, the S-MN may also start the CHO handover procedure by sending a handover request message or the like to one or more other T-MN(s), e.g., candidate target MN2 or candidate target MNm as shown in FIG. 2b.

In some cases, the S-MN may also indicate to the T-MN, time (second time) based on that information of sharing data forwarding address and/or one or more second estimated arrival probabilities etc. routing optimization information to be determined. For example, the second time is a time length of time to wait, indicating the maximum allowed waiting times to provide the information of sharing data forwarding address, and/or the maximum allowed waiting times to provide the second estimated arrival probabilities.

In step 603a1, the T-MN will send an SN addition request message or the like to a T-SN, including the CHO related information. In some embodiments of the present application, besides the S-MN ID and the UE ID allocated at the S-MN, the CHO related information may also include the estimated arrival probability for the UE towards the target SN prepared by the T-MN.

In some cases, the T-MN may also indicate to the T-SN, time (first time) based on that information related to a number of candidate target MNs using a same data forwarding address of the T-SN and/or one or more second estimated arrival probabilities etc. routing optimization related information to be determined. In the case that the second time is provided by the S-MN, the first time will be shorter or later than the first time. In some other cases the S-MN may directly indicate the first time based on that the routing optimization related information will be determined.

The T-MN may also send the same message to other T-SN(s) in step 603a2. Other T-MN(s) may perform identical or similar operations to the T-SN in step 603b1 and to other T-SN(s) in step 603b2.

The T-SN will reply with an SN addition request acknowledge message or the like in step 605a1. The SN addition request acknowledge message or the like includes data forwarding address allocated by the T-SN, which is related to a PDU session for DRBs configured with an SN terminated bearer option.

Similarly, the T-SN may also provide routing optimization related information to the T-MN in the same or the like message, to assist the T-MN to determine routing optimization information.

For example, similar to FIG. 3, in some embodiments of the present application, the T-SN may indicate an identity of the T-SN. An exemplary identity of the T-SN is a globally unique identity of the T-SN.

Similar to FIG. 4, in some embodiments of the present application, the T-SN may indicate information related to a number of candidate target MNs using the same data forwarding address explicitly with a numerical value, e.g., 3; or implicitly with at least identities of other T-MN(s) using the same data forwarding address of the T-SN. In the case that the first time is provided, the T-SN will determine the number of candidate target MNs using the same data forwarding address based on the first time.

In some cases, the T-SN may indicate estimated arrival probabilities from other T-MN(s) (second estimated arrival probability) to the T-MN. Each second estimated arrival probability is an estimated arrival probability for the UE towards the T-SN prepared by another candidate target MN. For example, if candidate target SN2 is also prepared by the candidate target MN2 and candidate target MNm besides candidate target MN1 as shown in FIG. 2b, candidate target SN2 will provide the second estimated arrival probabilities to candidate target MN1, including the estimated arrival probability from candidate target MN2 and the estimated arrival probability from candidate target MNm. In the case that the first time is provided, the T-SN will determine the second estimated arrival probabilities from other T-MN(s) based on the first time.

In addition, in FIG. 6, in the case that the first time is indicated, it is assumed that the T-SN will reply the SN addition request acknowledge message or the like in step 605al after the information related to a number of candidate target MNs using the same data forwarding address and/or the one or more second estimated arrival probabilities are obtained based on the first time. Thereby, the T-SN can indicate information related to a number of candidate target MNs using the same data forwarding address and/or the one or more second estimated arrival probabilities within the SN addition request acknowledge message or the like in step 405a1.

The T-SN may transmit at least one of the above routing optimization related information to the T-MN, e.g., only the identity of the T-SN, or only information related to a number of candidate target MNs using the same data forwarding address, or only the one or more second estimated arrival probabilities, or any combination of them.

The T-SN will reply similar messages to other T-MN(s) in step 605b1 if it receives similar messages from the other T-MN(s) in step 603b1. Other T-SN(s) will reply similar messages to the T-MN in step 605a2 and to other T-MN(s) in step 605b2, if they receive similar messages from the T-MN and the other T-MN(s) in steps 603a2 and 603b2.

After receiving the SN addition request acknowledge message or the like from T-SN, the T-MN will transmit a handover request acknowledge message or the like to the S-MN in step 607a, which includes a data forwarding address allocated by the T-MN. The data forwarding address is related to a PDU session for DRBs configured with an SN terminated bearer option.

The T-MN may also include the routing optimization information in the same message or different message(s). Based on the information received from the T-SN, the routing optimization information includes at least: identities of one or more candidate target SNs, e.g., by a list of T-SN identities prepared by the T-MN. The routing optimization information may further include at least one of: information of sharing data forwarding address, indicating the number of candidate target MNs using a same data forwarding address of the one candidate target SN; one or more first estimated arrival probabilities, each first estimated arrival probability for the UE towards a corresponding candidate target SN of one or more candidate target SNs prepared by the T-MN; or one or more second estimated arrival probabilities, each second estimated arrival probability for the UE towards a corresponding candidate target SN of the one or more candidate target SNs prepared by another candidate target MN different from the T-MN.

Exemplary routing optimization information, e.g. from T-MN1 is illustrated in Table 1 below. The exemplary information indicates: identities of T-SNs prepared by the T-MN, e.g., T-SN1 and T-SN2 prepared by T-MN1, wherein for each T-SN, Table 1 further indicates an estimated arrival probability (first estimated arrival probability) for the UE towards the T-SN prepared by the T-MN and estimated arrival probabilities (second estimated arrival probabilities) for the UE towards the T-SN prepared by other T-MNs (or, estimated arrival probabilities for the UE towards the T-SN from other T-MNs). Taking T-SN2 as an example, first estimated arrival probability from T-MN1 and second estimated arrival probability from T-MN4 are indicated.

TABLE 1

| | |
|---|---|
| T-SN1 | Estimated arrival probability from T-MN1 |
| | Estimated arrival probability from T-MN2 |
| | Estimated arrival probability from T-MN3 |
| T-SN2 | Estimated arrival probability from T-MN1 |
| | Estimated arrival probability from T-MN4 |

Other T-MN(s) will transmit similar message(s) to the S-MN in step 607b.

Based on the routing optimization information, the S-MN will perform routing optimization for data forwarding, e.g., select one candidate target MN for data forwarding and optionally further determine a destination for data forwarding for SN-terminated bearers, wherein the destination is the identity of a selected T-SN.

When the S-MN receives the data forwarding addresses from multiple T-MNs with T-SN identities, e.g., multiple T-SN identity lists, the S-MN may determine the T-MN for data forwarding based on the received T-SN identity lists. In some embodiments of the present application, the S-MN will select the T-MN with the maximum number of shared T-SNs. For example, it is assumed that T-MN1 provides the data forwarding addresses of T-SN1, T-SN2 and T-SN3, T-MN2 provides the data forwarding addresses of T-SN2, T-SN3 and T-SN4, T-MN3 provides the data forwarding address with T-SN3 and T-SN4, then the S-MN selects T-MN2 for data forwarding because the T-MN2 has the maximum number of shared T-SNs. In some other embodiments of the present application, the S-MN may select a T-MN with a maximum number of T-SNs as the candidate target MN for data forwarding. More manners can be adopted by the S-MN based on its implementation.

In the case that the estimated arrival probability for the UE towards the T-SN prepared by the T-MN (first estimated arrival probability and/or the second estimated arrival probability) is included in the routing optimization information, the S-MN may select the T-SN with the maximum estimated arrival probability for data forwarding.

For example, if the first estimated arrival probability towards candidate target SN1 as shown in FIG. 2b is 90% and the first estimated arrival probability towards candidate target SN2 is 70%, the S-MN will select candidate target SN1 as the destination for data forwarding. Destination notification will be performed in step 609, wherein the S-MN will notify the destination for data forwarding to the selected one T-MN. In the case that data forwarding will be performed by the source SN, the S-MN will also indicate to the source SN the destination for data forwarding.

In the case that the estimated arrival probabilities towards the T-SN prepared by other T-MN(s) (second estimated arrival probabilities) are included in the routing optimization information, the S-MN may process the estimated arrival probabilities associated with the same T-SN, e.g., averaging the first estimated arrival probability and second estimated arrival probabilities of the T-SN. For example, for candidate target SN1, the estimated arrival probability from candidate target MN1 is 90%, and the estimated arrival probability from candidate target MN2 is 50%; while for candidate target SN2, the estimated arrival probability from candidate target MN1 is 90%, the estimated arrival probability from candidate target MN2 is 80%, and the estimated arrival probability from candidate target MNm is 70%. In this case, the S-MN will derive the estimated arrival probability towards candidate target SN1 is 70%, while the estimated arrival probability towards the T-SN2 is 80%, and then the S-MN selects candidate target SN2 as the destination for data forwarding.

The source MN will perform the early data forwarding to the selected one T-MN; or indicate to the source SN the selected candidate target MN so that the source SN will perform the data forwarding to the selected candidate target MN.

In the case that the routing optimization information indicates the information of sharing data forwarding address, the S-MN may select the T-SN in a manner similar to that illustrated in FIG. 4.

In addition, in the case that the routing optimization information indicates multiple types of information as illustrated above, the S-MN will perform the routing optimization based on its implementation in various manners.

After the routing for data forwarding is optimized, the S-MN or source SN will perform the data forwarding based on the optimized routing, e.g., forwarding data only to the selected T-MN and then to the destination.

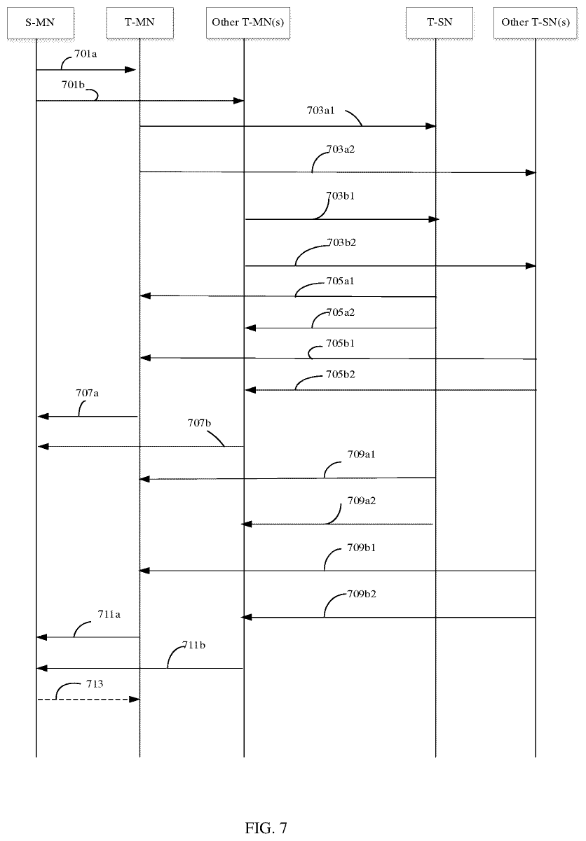

FIG. 7 is a flow chart of another exemplary procedure of supporting data forwarding in Scenario 3 according to some other embodiments of the present application. Similarly, although there are multiple candidate target MNs and multiple candidate target SNs, operations of only one candidate target MN and one candidate target SN at least prepared by the candidate target MN are illustrated as an example in detail for simplification and clearness. Persons skilled in the art should well know the corresponding operation in other candidate target MN(s) and candidate target SN(s) under the disclosure and teaching of the specifically illustrated candidate target MN and candidate target SN, which may be the same as, or similar to, or different from that of the illustrated target MN due to adopting the same, or similar, or different solutions taught by various embodiments of the present application.

Compared with FIG. 6, FIG. 7 differs in that part of all of the routing optimization related information will be transmitted to the T-MN in an SN modification required message rather than an SN addition request ACK message. Steps 701a to 703b2 are identical with steps 601a to 603b2; and steps 705al to 705b2 can also refer to steps 605al to 605b2, wherein, only legacy SN addition request ACK message will be sent and no routing optimization related information or only part, e.g., T-SN identity will be sent to the T-MN.

In step 707a, the T-MN may only reply a handover request ACK message, or include within the handover request ACK message, routing optimization information indicating at least: identities of T-SNs prepared by the T-MN. The routing optimization information may further include estimated arrival probabilities (first estimated arrival probabilities) for the UE towards each T-SN prepared by the T-MN. It is similar in step 707b.

In the case of receiving the routing optimization information indicating identities of T-SNs and optionally first estimated arrival probabilities, the S-MN may perform routing optimization based on the received routing optimization information as illustrated above or wait for further routing optimization information.

In step 709a1, the T-SN will transmit at least one of information related to a number of candidate target MNs using the same data forwarding address or the one or more second estimated arrival probabilities to the T-MN, e.g., by an SN modification required message or the like. It is similar in steps 709a2 to 709b2.

In some cases, the T-MN may indicate first time based on that the information related to a number of candidate target MNs using the same data forwarding address of the SN will be provided, e.g., including in the SN addition request message or the like in step 703a1. The T-SN will determine the number of candidate target MNs using the same data forwarding address based on the indicated time. In the case that the T-MN receives second time based on that the information of sharing data forwarding address will be provided from the S-MN, e.g., including the handover request message in step 701a, the first time will be equal to or shorter than the second time.

Similarly, in some case, the T-MN may indicate first time based on that the one or more second estimated arrival probabilities will be provided, e.g., including in the SN addition request message or the like in step 703a1. The T-SN will determine the one or more second estimated arrival probabilities based on the indicated time based on the indicated time. In the case that the second time based on that the one or more second estimated arrival probabilities is provided from the S-MN, e.g., including the handover request message in step 701a, the first time will be equal to or shorter than the second time.

After receiving the routing optimization related information from the T-SN, e.g., indicating at least one of the information related to a number of candidate target MNs using the same data forwarding address or the one or more second estimated arrival probabilities based on the indicated time, the T-MN will transmit routing optimization information including the information of sharing data forwarding address and/or the one or more second estimated arrival probabilities to the S-MN in step 711a, e.g., by a message after the handover request ACK message. In some embodiments of the present application, the T-MN may not transmit any routing optimization information to the S-MN in step 707a, and will transmit the routing optimization information including at least one of: identities of T-SN prepared by the T-MN, the first estimated arrival probabilities of the T-SNs; the information of sharing data forwarding address, or second estimated arrival probabilities of the T-SNs as illustrated in step 607a.

Other T-MN(s) will transmit similar message(s) to the S-MN in step 711b.

Similar to FIG. 6, based on the routing optimization information, the S-MN will select (or determine) one candidate target MN for data forwarding or determine a destination for SN-terminated bearers. In the case that the destination is determined, the S-MN will notify it to the T-MN or indicate to a source SN in step 713 before the data forwarding.

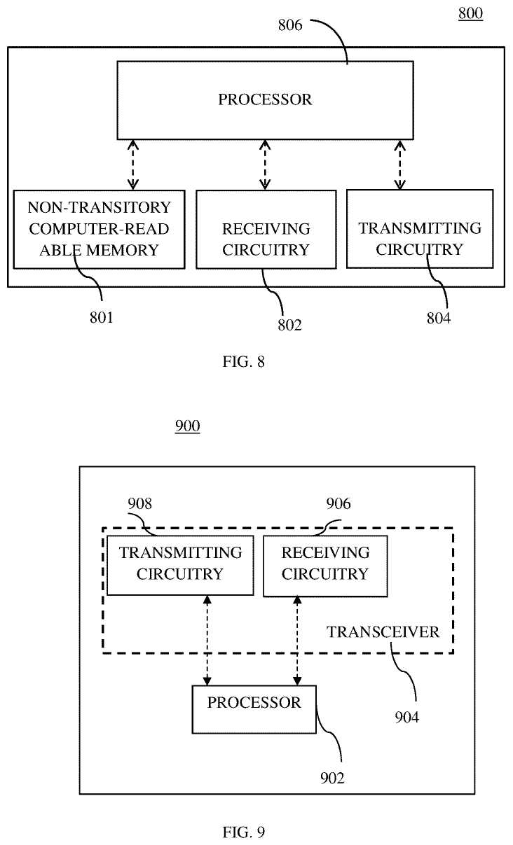

Besides methods, embodiments of the present application also propose an apparatus of supporting data forwarding. For example, FIG. 8 is a block diagram of an apparatus of supporting data forwarding according to some embodiments of the present application.

As shown in FIG. 8, the apparatus 800 may include at least one non-transitory computer-readable medium 801, at least one receiving circuitry 802, at least one transmitting circuitry 804, and at least one processor 806 coupled to the non-transitory computer-readable medium 801, the receiving circuitry 802 and the transmitting circuitry 804. The apparatus 800 may be a RAN node (e.g., an MN or an SN) configured to perform a method illustrated in the above or the like.

Although in this figure, elements such as the at least one processor 806, transmitting circuitry 804, and receiving circuitry 802 are described in the singular, the plural is contemplated unless a limitation to the singular is explicitly stated. In some embodiments of the present application, the receiving circuitry 802 and the transmitting circuitry 804 can be combined into a single device, such as a transceiver. The processor 806 may be a central processing unit (CPU), a digital signaling processing (DSP), a microprocessor etc. In certain embodiments of the present application, the apparatus 800 may further include an input device, a memory, and/or other components.

In some embodiments of the present application, the non-transitory computer-readable medium 801 may have stored thereon computer-executable instructions to cause the processor 806 to implement the method with respect to the RAN node, e.g., a MN or SN as described above. For example, the computer-executable instructions, when executed, cause the processor 806 interacting with receiving circuitry 802 and transmitting circuitry 804, so as to perform the steps with respect to a RAN node as depicted above.

FIG. 9 illustrates a block diagram of an apparatus 700 of supporting data forwarding according to some other embodiments of the present application.

Referring to FIG. 9, the apparatus 900, e.g., an MN or SN may include at least one processor 902 and at least one transceiver 904. The transceiver 904 may include at least one separate receiving circuitry 906 and transmitting circuitry 908, or at least one integrated receiving circuitry 906 and transmitting circuitry 908. The at least one processor 902 may be a CPU, a DSP, a microprocessor etc.

According to some embodiments of the present application, when the apparatus 900 is an MN, e.g., a candidate target MN, the processor is configured to: determine information of routing optimization for early data forwarding associated with one or more candidate target SNs at least prepared by the MN, wherein the early data forwarding is for a CHO with SCG of a UE; and a transceiver, coupled to the processor and configured to: transmit the information of routing optimization to a source MN.

According to some other embodiments of the present application, when the apparatus 900 is an MN, e.g., a source MN, the processor may be configured to: transmit, to a candidate target MN of one or more candidate target MNs, a handover request for a CHO with SCG of a UE; and receive, from the candidate target MN, information of routing optimization for early data forwarding associated with one or more candidate target SNs at least prepared by the candidate target MN, wherein the early data forwarding is for the CHO with SCG.

According to some other embodiments of the present application, when the apparatus 900 is an SN, e.g., a candidate target SN, the processor may be configured to: receive, from a candidate target MN, first information related to a CHO with SCG of a UE; and transmit, to the candidate target MN, second information related to routing optimization for early data forwarding for the CHO with SCG.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device capable of implementing the flowcharts shown in the figures may be used to implement the processor functions of this application. For example, an embodiment of the present application provides an apparatus including a processor and a memory. Computer programmable instructions for implementing a method stored in the memory, and the processor is configured to perform the computer programmable instructions to implement the method. The method may be a method as stated above or other method according to an embodiment of the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as random access memory (RAMs), read only memory (ROMs), flash memory, electrically erasable programmable read only memory (EEPROMs), optical storage devices (compact disc (CD) or digital video disc (DVD)), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method as stated above or other method according to an embodiment of the present application.

While this application has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the application by simply employing the elements of the independent claims. Accordingly, embodiments of the application as set forth herein are intended to be illustrative, not limiting. Various changes may be made without departing from the spirit and scope of the application.

1. A master node (MN) for wireless communication, comprising:
at least one memory; and
at least one processor coupled with the at least one memory and configured to cause the MN to:
determine information of routing optimization for early data forwarding associated with one or more candidate target secondary nodes (SNs) prepared by the MN, wherein the early data forwarding is for a conditional handover (CHO) with secondary cell group (SCG) of a user equipment (UE); and
transmit the information of routing optimization to a source MN.

2. The MN of claim 1, wherein the information of routing optimization indicates at least one of:
an identity of one candidate target SN of the one or more candidate target SNs;
a random number allocated at the one candidate target SN; or
an indicator of a same candidate target SN, indicating that a data forwarding address associated with the early data forwarding will map to a same data forwarding address of the one candidate target SN.

3. The MN of claim 2, wherein the information of routing optimization further indicates an estimated arrival probability for the UE towards the one candidate target SN prepared by the MN.

4. The MN of claim 2, wherein the at least one processor is further configured to cause the MN to:
receive information indicating that the same data forwarding address is shared by one or more other candidate target MNs with the MN, so that the indicator of the same candidate target SN is determined by the MN.

5. The MN of claim 1, wherein the information of routing optimization indicates at least one of:
an estimated arrival probability for the UE towards one candidate target SN, prepared by the MN, of the one or more candidate target SNs; or
information of sharing data forwarding address, indicating a number of candidate target MNs using a same data forwarding address of the one candidate target SN.

6. The MN of claim 1, wherein the information of routing optimization indicates
identities of the one or more candidate target SNs.

7. The MN of claim 5, wherein information related to a number of candidate target MNs using the same data forwarding address of the one candidate target SN is indicated by the one candidate target SN via an SN addition request acknowledge message or an SN modification required message.

8. The MN of claim 7, wherein the at least one processor is further configured to:
transmit, to the one candidate target SN, information indicating a first time that the information related to the number of candidate target MNs using the same data forwarding address of the one candidate target SN will be provided; and
receive the information related to the number of candidate target MNs using the same data forwarding address of the one candidate target SN.

9. The MN of claim 7, wherein the information related to the number of candidate target MNs using the same data forwarding address of the one candidate target SN is indicated by the one candidate target SN with a numerical value or with at least identities of other candidate target MNs using the same data forwarding address in addition to the MN.

10. The MN of claim 6, wherein the at least one processor is further configured to:
transmit, to a candidate target SN, information indicating a first time that estimated arrival probabilities associated with the candidate target SN will be provided; and
receive a message indicating the estimated arrival probabilities associated with the candidate target SN.

11. The MN of claim 6, wherein the at least one processor is further configured to:
receive, from the source MN, a destination for data forwarding for SN-terminated bearers, wherein the destination is an identity of a target SN determined by the source MN.

12. A master node (MN) for wireless communication, comprising:
at least one memory; and
at least one processor coupled with the at least one memory and configured to cause the MN to:
transmit, to a candidate target MN of one or more candidate target MNs, a handover request for a conditional handover (CHO) with secondary cell group (SCG) of a user equipment (UE); and
receive, from the candidate target MN, information of routing optimization for early data forwarding associated with one or more candidate target secondary nodes (SNs) prepared by the candidate target MN, wherein the early data forwarding is for the CHO with SCG.

13. (canceled)

14. (canceled)

15. (canceled)

16. A method performed by a master node (MN), the method comprising:
determining information of routing optimization for early data forwarding associated with one or more candidate target secondary nodes (SNs) prepared by the MN, wherein the early data forwarding is for a conditional handover (CHO) with secondary cell group (SCG) of a user equipment (UE); and
transmitting the information of routing optimization to a source MN.

17. The method of claim 16, wherein the information of routing optimization indicates at least one of:
an identity of one candidate target SN of the one or more candidate target SNs;
a random number allocated at the one candidate target SN; or
an indicator of a same candidate target SN, indicating that a data forwarding address associated with the early data forwarding will map to a same data forwarding address of the one candidate target SN.

18. The method of claim 17, wherein the information of routing optimization further indicates an estimated arrival probability for the UE towards the one candidate target SN prepared by the MN.

19. The method of claim 17, further comprising:
receiving information indicating that the same data forwarding address is shared by one or more other candidate target MNs with the MN, so that the indicator of the same candidate target SN is determined by the MN.

20. The method of claim 16, wherein the information of routing optimization indicates at least one of:
an estimated arrival probability for the UE towards one candidate target SN, prepared by the MN, of the one or more candidate target SNs; or
information of sharing data forwarding address, indicating a number of candidate target MNs using a same data forwarding address of the one candidate target SN.

21. The method of claim 16, wherein the information of routing optimization indicates identities of the one or more candidate target SNs.

22. The method of claim 20, wherein information related to a number of candidate target MNs using the same data forwarding address of the one candidate target SN is indicated by the one candidate target SN via an SN addition request acknowledge message or an SN modification required message.

23. A method performed by a master node (MN), the method comprising:
transmitting, to a candidate target MN of one or more candidate target MNs, a handover request for a conditional handover (CHO) with secondary cell group (SCG) of a user equipment (UE); and
receiving, from the candidate target MN, information of routing optimization for early data forwarding associated with one or more candidate target secondary nodes (SNs) prepared by the candidate target MN, wherein the early data forwarding is for the CHO with SCG.
